(19) United States
(12) Patent Application Publication
(10) Pub. No.: US 2026/0116068 A1
(43) Pub. Date: Apr. 30, 2026

(54) FLOW CHANNEL MEMBER, LIQUID EJECTION HEAD, AND METHOD FOR MOLDING FLOW CHANNEL MEMBER

(71) Applicant: CANON KABUSHIKI KAISHA, Tokyo (JP)

(72) Inventors: SHIMPEI YOSHIKAWA, Kanagawa (JP); YASUAKI KITAYAMA, Kanagawa (JP); YUKUO YAMAGUCHI, Tokyo (JP); RYO SATO, Kanagawa (JP); DAIKI YAMAMOTO, Kanagawa (JP)

(21) Appl. No.: 19/370,312

(22) Filed: Oct. 27, 2025

(30) Foreign Application Priority Data
Oct. 31, 2024 (JP) 2024-191485

(51) Int. Cl. B41J 2/14; B29C 45/14; B29L 31/00; B41J 2/16

(52) U.S. Cl. CPC B41J 2/14; B41J 2/16; B41J 2/1623; B41J 2/1637; B29C 45/14508; B29L 2031/7678

(57) ABSTRACT

A technique for reducing product damage is provided. To this end, a joining resin has, in at least one of a first molded product and a second molded product, a penetration portion penetrating through the molded product in a lamination direction in which the molded products are laminated and an anchor portion having a larger cross-sectional area than the rest of the penetration portion.

### BACKGROUND

### Field of the Technology

The present disclosure relates to a flow channel member, a liquid ejection head, and a method for molding the flow channel member.

### Description of the Related Art

Japanese Patent Laid-Open No. 2018-16026 discusses a technique for producing a finished molded product by using a fixed die and a movable die to mold two components simultaneously inside the dies, and then assembling these two components inside the molding dies. According to Japanese Patent Laid-Open No. 2018-16026, two components are molded simultaneously at different locations in the same dies (first molding). Then, the dies are opened, the movable die is moved to a position where the two components face each other, and the dies are closed. In this state, the two components abut against each other, and a hollow flow channel for pouring molten resin is formed at a position between the two components. Molten resin is poured into the hollow flow channel to join and seal the two components, producing a finished product (second molding).

According to Japanese Patent Laid-Open No. 2018-16026, one of the components formed by the first molding and held on a first one of the dies after the dies are opened after the first molding is, after the molds are opened after the second molding, separated from the first die and is held onto the other die. In this event, demolding resistance occurs between the first die and the component formed by the first molding, and the component formed by the first molding held on the first mold receives stress in such a direction as to be pulled toward the first mold. When this stress is intense, a fragile portion of the product, i.e., a joint interface between the two components, may be damaged.

### SUMMARY

Thus, the present disclosure provides a technique for reducing product damage.

To this end, a flow channel member is provided that includes a first molded product, a second molded product configured to be laminated to the first molded product in a lamination direction, a resin configured to join the first molded product and the second molded product to each other, and a penetration portion. The penetration portion penetrates at least one of the first molded product and the second molded product in the lamination direction. The penetration portion includes a first region and a second region having a larger cross-sectional area than the first region, viewed in the lamination direction.

The present disclosure provides a technique for reducing product damage.

Features of the present disclosure will become apparent from the following description of embodiments with reference to the attached drawings. The following description of embodiments is described by way of example.

### BRIEF DESCRIPTION OF THE DRAWINGS

FIG. 1A is a schematic perspective view of a liquid ejection apparatus.

FIG. 1B is a block diagram showing a control system of the liquid ejection apparatus.

FIG. 2 is an exploded perspective view of a liquid ejection head.

FIG. 3 is a schematic external view showing a circulation unit applied to the liquid ejection apparatus.

FIG. 4 is a schematic view showing a circulation path for one ink color applied to the liquid ejection apparatus.

FIG. 5 is a front surface view showing an ejection unit.

FIG. 6 is a back surface view showing ejection element substrates.

FIG. 7 is a back surface view showing a support member.

FIG. 8 is an exploded perspective view of a flow channel member.

FIG. 9A is a schematic diagram of a molding process.

FIG. 9B is a schematic diagram of the molding process.

FIG. 9C is a schematic diagram of the molding process.

FIG. 9D is a schematic diagram of the molding process.

FIG. 10A is a schematic diagram showing a prior art molding process, in prior art as a comparative example.

FIG. 10B is a schematic diagram showing the prior art molding process, in prior art as a comparative example.

FIG. 11A is a diagram showing a method for forming an anchor formation portion in a second layer.

FIG. 11B is a diagram showing the method for forming an anchor formation portion in a second layer.

FIG. 12A is a diagram showing a first step of the process for molding the flow channel member.

FIG. 12B is a diagram showing the first step of the process for molding the flow channel member.

FIG. 13A is a diagram showing a second step of the process for molding the flow channel member.

FIG. 13B is a diagram showing the second step of the process for molding the flow channel member.

FIG. 13C is a diagram showing the second step of the process for molding the flow channel member.

FIG. 14A is a diagram showing a third step of the process for molding the flow channel member.

FIG. 14B is a diagram showing the third step of the process for molding the flow channel member.

FIG. 14C is a diagram showing the third step of the process for molding the flow channel member.

FIG. 15A is a diagram showing a fourth step of the process for molding the flow channel member.

FIG. 15B is a diagram showing the fourth step of the process for molding the flow channel member.

FIG. 15C is a diagram showing the fourth step of the process for molding the flow channel member.

FIG. 15D is a diagram showing the fourth step of the process for molding the flow channel member.

FIG. 16 is a schematic diagram of a molding process according to another embodiment.

FIG. 17A is a schematic diagram of a molding process, showing a joining resin.

FIG. 17B is a schematic diagram of a molding process, showing the joining resin.

FIG. 18A is a schematic diagram of a molding process, showing a joining resin.

FIG. 18B is a schematic diagram of a molding process showing the joining resin.

FIG. 18C is a schematic diagram of a molding process showing the joining resin.

### DESCRIPTION OF THE EMBODIMENTS

A first embodiment of the present disclosure is described below with reference to the drawings.

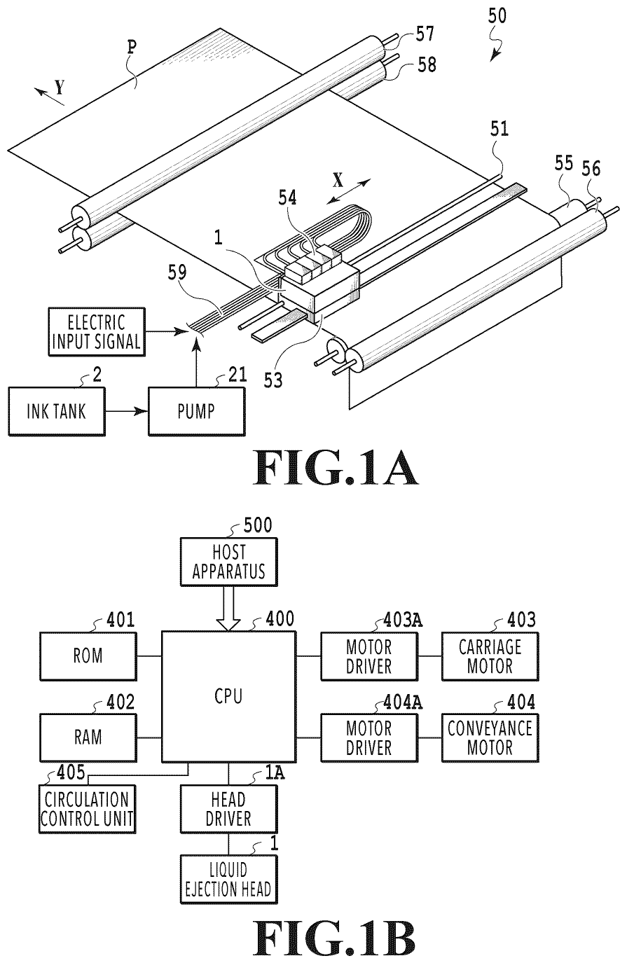

FIG. 1A is a schematic perspective view of a liquid ejection apparatus 50 using a liquid ejection head 1, and FIG. 1B is a block diagram showing a control system of the liquid ejection apparatus 50. The liquid ejection apparatus 50 is a serial-scan inkjet printing apparatus configured to print an image on a printing medium P by ejecting ink from the liquid ejection head 1. The liquid ejection head 1 is carried by a carriage 53 which moves along a guide shaft 51 in a main scanning direction (an X-direction). The print medium P is conveyed by conveyance rollers 55, 56, 57, and 58 in a sub scanning direction (a Y-direction) intersecting with (in this example, orthogonal to) the main scanning direction. The liquid ejection head 1 is equipped with ink circulation units 54 to circulate ink through an ejection unit (liquid ejection unit) 300 to be described later as controlled by a circulation control unit 405. Ejection energy generation elements in the ejection unit 300 are driven by a head driver 1A according to signals inputted from an electric connection substrate. Electric wiring and ink and air piping necessary for ejection are supplied to the carriage 53 through guides 59.

A central processing unit (CPU) (control unit) 400 controls the liquid ejection apparatus 50 based on programs of procedures, processes, and the like stored in a read only memory (ROM) 401, and a random access memory (RAM) 402 is used as, e.g., a work area for executing the processes. The CPU 400 controls the head driver 1A based on image data from an external host apparatus 500 for the liquid ejection apparatus 50. The CPU 400 also controls a carriage motor 403 for moving the carriage 53 via a motor driver 403A and controls a conveyance motor 404 for conveying the printing medium P via a motor driver 404A.

The liquid ejection head 1 is capable of full-color printing using CMYK (cyan, magenta, yellow, and black) inks. A cap member is disposed at a position offset from a conveyance path for the printing medium P, and while no printing operation is performed, moves to a position for covering the face of the liquid ejection head 1 where ejection ports are formed in order to prevent the ejection ports from drying and to perform a suction operation for filling or recovery.

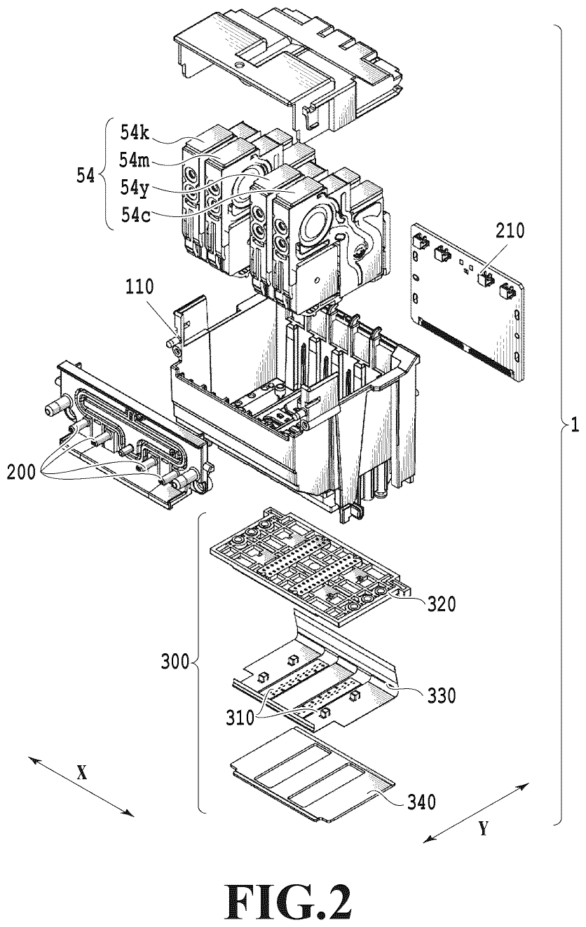

FIG. 2 is an exploded perspective view of the liquid ejection head 1. The liquid ejection head 1 has the circulation units 54. The circulation units 54 include circulation units 54m, 54y, 54k, and 54c corresponding to the respective inks, fluidically connected to a flow channel member 110. The circulation units 54 and the flow channel member 110 may be connected by a connection method such as screwing them together with a seal member interposed in between or welding. Joint members 200 are connected to the flow channel member 110 to receive the inks from the main body of the liquid ejection apparatus 50, and the joint members 200 are connected to and communicate with the circulation units 54m, 54k, 54y, and 54c. For attachment to the main body of the liquid ejection apparatus 50, supply tubes corresponding to the respective inks are connected to the joint members 200. The inks supplied from the respective supply tubes pass through the joint members 200 connected to the flow channel member 110 and are supplied to the respective circulation units 54m, 54k, 54y, and 54c.

The ejection unit 300 is connected to a bottom surface of the flow channel member 110. The flow channel member 110 has flow channels formed inside to allow liquid to flow. The flow channel member 110 is configured to supply inks to the ejection unit 300, and inks supplied to the circulation units 54 are supplied to the ejection unit 300 through the flow channel member 110. The ejection unit 300 includes ejection element substrates 310 where ejection elements with actuators for ink ejection are arrayed, a support member 320, an electric wiring substrate 330 for sending electric signals to the ejection elements, and a cover member 340 covering the electric wiring substrates. The ejection element substrates 310 and the electric wiring substrate 330 are attached and fixed to the support member 320, and then the cover member 340 is further attached and joined to cover the surface of the electric wiring substrate 330. The ejection element substrates 310 and the electric wiring substrate 330 are electrically connected by wire bonding. The electrical connection method may instead be flying lead bonding or the like.

The cover member 340 has openings at locations corresponding to the ejection element substrates 310. The ejection unit 300 and the flow channel member 110 may be connected by attachment using an adhesive or fixation by screwing with a seal member interposed in between. The surface of the flow channel member 110 opposite from the surface where the joint members 200 are provided is a contact surface, and an electric board 210 that receives electric signals from the main body is connected to the contact surface. The electric signals are sent from the electric board 210 to the ejection element substrates 310 via the electric wiring substrate 330 of the ejection unit 300. The connection between the electric board 210 and the flow channel member 110 may be established by fixation using swaging, adhesive, or fixation using a double-sided tape. Electric connection between the electric board 210 and the electric wiring substrate 330 is formed by anisotropic conductive film (ACF) compression bonding here, but may be wiring bonding or flying lead bonding.

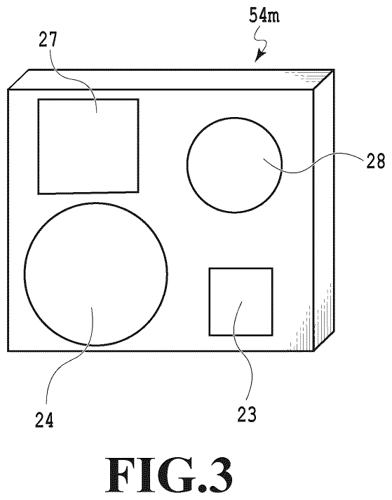

FIG. 3 is a schematic external view of the circulation unit 54m applied to the liquid ejection apparatus 50. Because the circulation units 54m, 54k, 54y, and 54c have the same configuration, the description of circulation unit 54m is incorporated by reference regarding circulation units 54k, 54y, and 54c. The circulation unit 54m corresponds to the magenta ink and includes a first pressure adjustment mechanism 24, a second pressure adjustment mechanism 28, a filter 23, and a circulation pump 27.

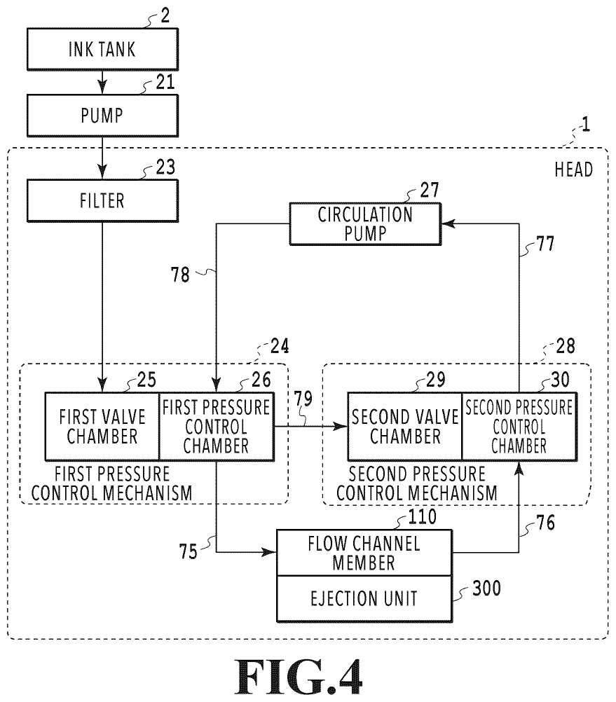

FIG. 4 is a schematic view showing a circulation path for one ink color applied to the liquid ejection apparatus 50. Ink is pressurized and supplied by a pump 21 from an ink tank 2 to the liquid ejection head 1. Foreign matter is removed by passing the ink through the filter 23, that is then supplied to a first valve chamber 25 of the first pressure adjustment mechanism 24. After that, pressure of the ink is adjusted at the time of flowing into a first pressure control chamber 26 communicating with the first valve chamber 25 with a valve in between. The circulation pump 27 is a piezoelectric diaphragm pump configured to pump liquid. To pump the liquid, a drive voltage is inputted to a piezoelectric element attached to a diaphragm to change the volume of a pump chamber, causing two check valves to move alternately due to pressure fluctuations. The circulation pump 27 pumps the ink from a pump entry flow channel 77, which is at a downstream side, to a pump exit flow channel 78, which is at an upstream side. The ink which is in the first pressure control chamber 26 and has been adjusted in pressure is supplied to a supply flow channel 75 and a bypass flow channel 79 as driven by the circulation pump 27. The supply flow channel 75 is a flow channel formed by the flow channel member 110 and is connected to the ejection unit 300. A collection flow channel 76 is also a flow channel formed by the flow channel member 110 and connected to the ejection unit 300. The ink supplied to the supply flow channel 75 passes through ejection ports formed in the ejection element substrates 310 of the ejection unit 300 (see FIG. 2), is discharged to the collection flow channel 76, and is then supplied to a second pressure control chamber 30 of the second pressure adjustment mechanism 28. Also, ink supplied to a second valve chamber 29 of the second pressure adjustment mechanism 28 is supplied to the second pressure control chamber 30 communicating with the second valve chamber 29 with a valve interposed in between. The ink supplied to the second pressure control chamber 30 is supplied to the pump entry flow channel 77, passes through the circulation pump 27, is supplied to the pump exit flow channel 78, and is then supplied to the first pressure control chamber 26. Circulation of the ink by the circulation pump 27 through the ejection ports in the ejection element substrates 310 can reduce thickening of ink near the ejection ports in the ejection element substrates 310.

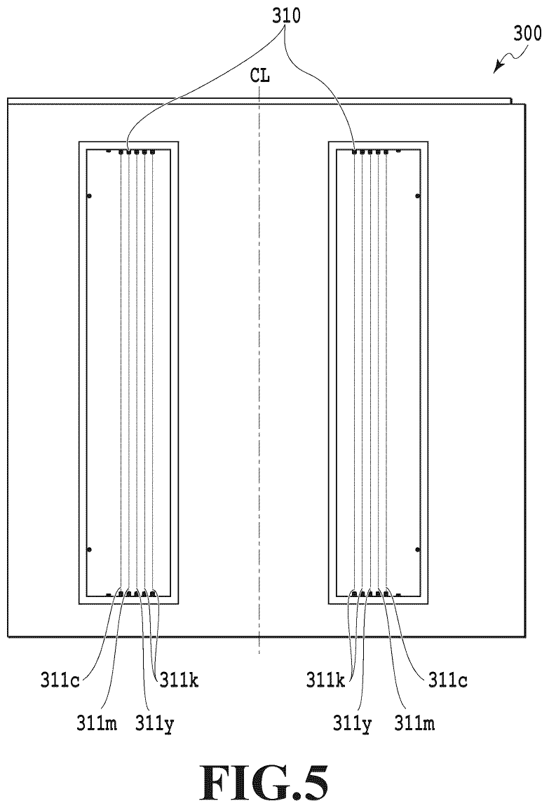

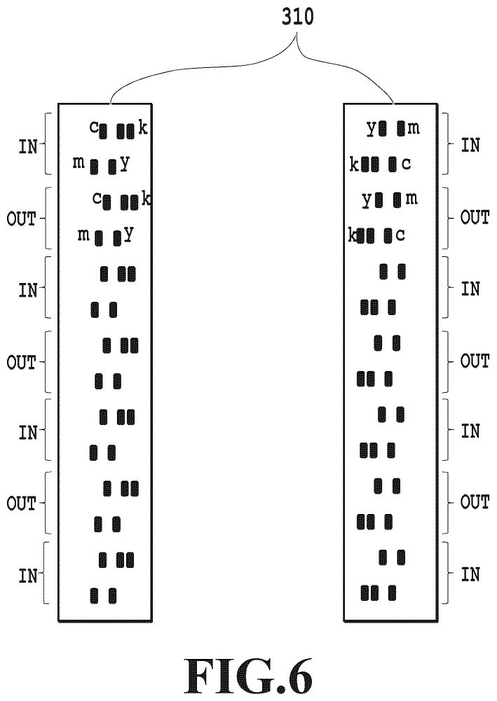

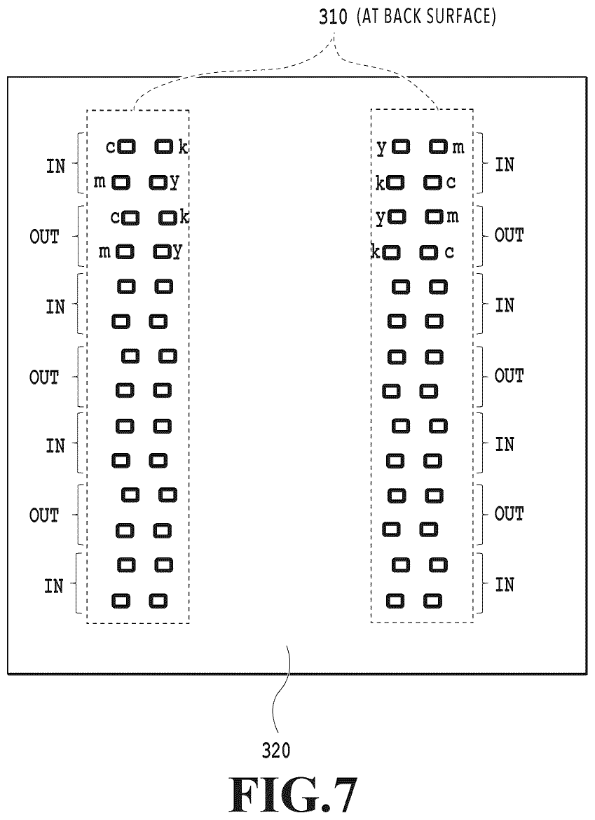

FIG. 5 is a front surface view of the ejection unit 300 (showing an ejection port surface), FIG. 6 is a back surface view showing the ejection element substrates 310, and FIG. 7 is a back surface view showing the support member 320. As shown in FIG. 5, two ejection element substrates 310 are disposed at the ejection unit 300. Each of the two ejection element substrates 310 has five nozzle arrays 311c, 311m, 311y, and 311k (with two nozzle arrays 311k), and these two sets of nozzle arrays are symmetric with respect to a center line CL.

Although the nozzle arrays are shown as being arranged at the two ejection element substrates 310 with symmetrical lines, a one nozzle array, a three nozzle array, or an array of more than three nozzles may be provided. Also, the array need not be arranged with line symmetry, and the advantageous effect of the flow channel configuration described herein can be achieved with a system having two or more nozzle arrays corresponding to the same color.

As shown in FIGS. 6 and 7, the ejection element substrates 310 and the support member 320 have a plurality of openings. Ink is supplied from the supply flow channel 75 to the openings denoted as IN and is discharged to the collection flow channel 76 through the openings denoted as OUT after passing through the plurality of ejection ports on the ejection element substrates 310. In this example, each nozzle array has four IN openings and three OUT openings, without limitation to the specific number of openings. A nozzle array may have more openings or have a single large IN opening and a single large OUT opening for its entire region.

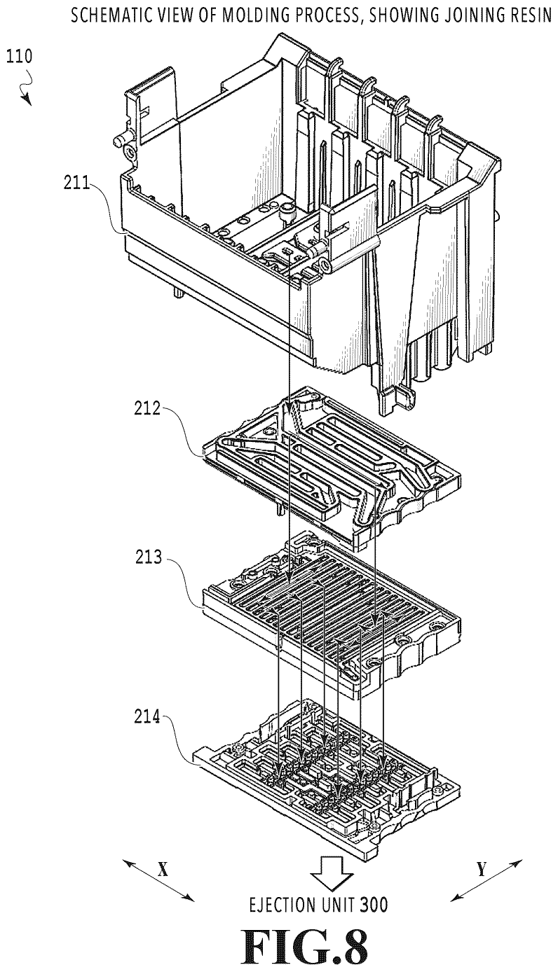

FIG. 8 is an exploded perspective view of the flow channel member 110. The flow channel member 110 is a multi-layered flow channel member formed by four layers: a first layer 211, a second layer 212, a third layer 213, and a fourth layer 214. The flow channel configuration of the flow channel member 110 may be sequentially provided along an ink supply flow channel.

The ink supplied from the circulation unit 54 (FIG. 2) passes through the first layer 211 and is supplied to the second layer 212. The ink supplied to the second layer 212 is divided to be supplied to two nozzle arrays. The ink supplied from the second layer 212 to the third layer 213 is supplied to positions corresponding four IN openings through a horizontal flow channel extending in a nozzle array direction (the Y-direction) in the third layer 213. Further, the ejection-unit-side surface of the third layer 213 form path conversion flow channels for supplying the ink to the openings in the support member 320 of the ejection unit 300, and the ink is supplied to positions corresponding to the ejection unit 300.

The ink supplied to the ejection unit 300 passes through ejection port portions of the ejection element substrates 310 and is collected back to the flow channel member 110. Each of the three OUT openings in the support member 320 is connected to the fourth layer 214, and the path is converted in the third layer 213, bundling three tributaries into one flow channel. Further, flow channels for the two nozzle arrays are bundled into one flow channel in the second layer 212, and the ink is collected to the circulation unit 54.

Such a flow channel member 110 is completed by simultaneously molding the first layer 211, the second layer 212, the third layer 213, and the fourth layer 214 in dies, as a first molding step, and assembling the simultaneously molded first through fourth layers 211-214 in the molding dies, as second molding to fourth molding steps. After being assembled by such a molding method, the finished molded product is removed from the dies as the flow channel member 110. After the first molding, every time the dies are opened, demolding resistance occurs between the die and the product obtained by the first molding, applying stress to the product formed by the first molding in a direction pulling the product toward the die which is moving away therefrom. In a case of intense stress, peeling may occur at a fragile portion of the flow channel member 110, i.e., at the joint interface between the products formed by the first molding, damaging the flow channel member 110.

Thus, in the present embodiment, an anchoring portion is formed at a joint portion, to avoid peeling at the joint interface between products of the first molding, as described below.

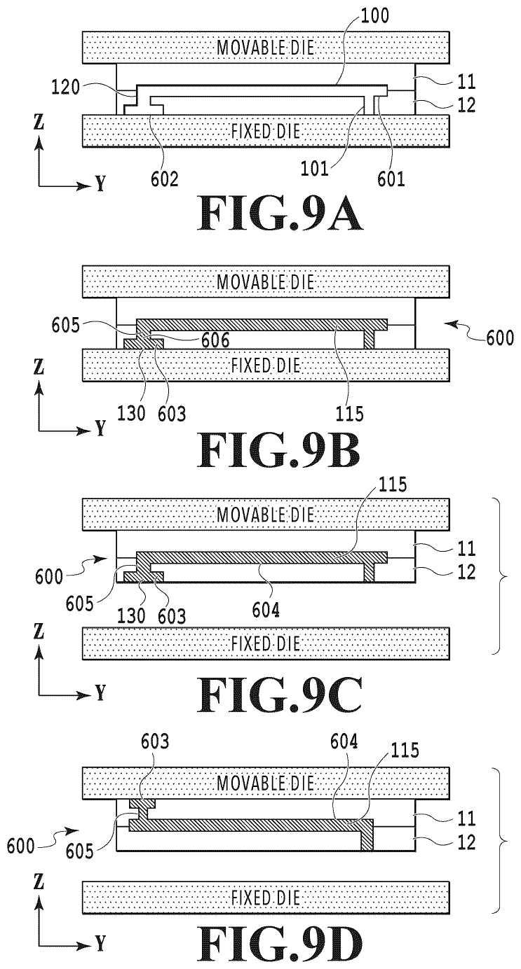

FIGS. 9A to 9D are schematic diagrams showing a molding process employed in the present embodiment. A process of forming a joined product 600 by joining, in second molding, a first molded product 11 and a second molded product 12 molded in first molding, as described herein as an example of the molding process. From FIG. 9A onward, the Y-direction represents a direction that is different from direction indicated by the arrow Y in FIGS. 1A, 2, and 8.

From FIG. 9A onward, the Z-direction represents the direction in which a movable die and a fixed die are opened, hereinafter referred to as the lamination direction. The Y-direction represents a direction in which the movable die is moved relative to the fixed die to make the products of the first molding face each other. The Y-direction in FIGS. 9A to 9D differs from the Y-direction (conveyance direction) shown in FIGS. 1, 2A and 8.

In the first molding, the first molded product 11 and the second molded product 12 are individually molded at different locations in the dies, and the dies are opened. With the dies open, the first molded product 11 is held on the movable die, and the second molded product 12 is held on the fixed die. Next, the movable die is moved in the Y-direction to bring the first molded product 11 to a location facing the second molded product 12, and the dies are closed (see FIG. 9A). As a result of closing the dies, a space 601 is formed by the first molded product 11 and the second molded product 12.

The space 601 includes an extension space 100 extending in a direction parallel to a joint surface between the first molded product 11 and the second molded product 12 and a gate portion 101 connected to one end of the extension space 100 and used to pour a joining resin into the space 601. The space 601 includes a penetration space 120 connected to the extension space 100 at a location different from the gate portion 101 and extending in the Z-direction toward the fixed die; and an anchor formation portion 602 connected to the penetration space 120 and abutting against the fixed die. The anchor formation portion 602 has a larger cross-sectional area than the penetration space 120, viewed in the Z-direction.

After the dies are closed in the state in FIG. 9A, a joining resin 115 is poured through the gate portion 101 into the space 601 formed by the closing of the dies, thereby joining the first molded product 11 and the second molded product 12 to each other (see FIG. 9C). As a result of pouring the joining resin 115 into the space 601, a penetration portion 605 including an anchor portion 603 with a superficial portion 130 is formed.

After that, the dies are opened, and the finished joined product 600 is held on the movable die (see FIG. 9C).

At the time of opening the dies, demolding resistance occurs at the second molded product 12 held on the fixed die, applying stress to the joined product 600. This stress acts through the second molded product 12 in a direction (the −Z-direction) to detach the joint interface between the first molded product 11 and the second molded product 12. For example, the stress may act to detach a joint interface 604 between the joining resin 115 and the second molded product 12, possibly leading to defective molding due to interface delamination. However, the anchor portion 603 according to an embodiment distributes the stress trying to detach the joint interface 604 that is applied to the joining resin 115 through the anchor portion 603. Thus, the strength of the joint between the second molded product 12 and the joining resin 115 is reinforced, reducing the stress that is otherwise concentrated at the joint interface 604, and reducing the likelihood of detachment of the joint interface 604.

As shown in FIG. 9D, the anchor portion 603 may be provided at the first molded product 11. This reinforces the strength of the joint between the first molded product 11 and the joining resin 115, making the stress from the fixed die caused by the demolding resistance less concentrated on the joint interface 604 between the first molded product 11 and the joining resin 115, reducing the likelihood of detachment of the joint interface 604.

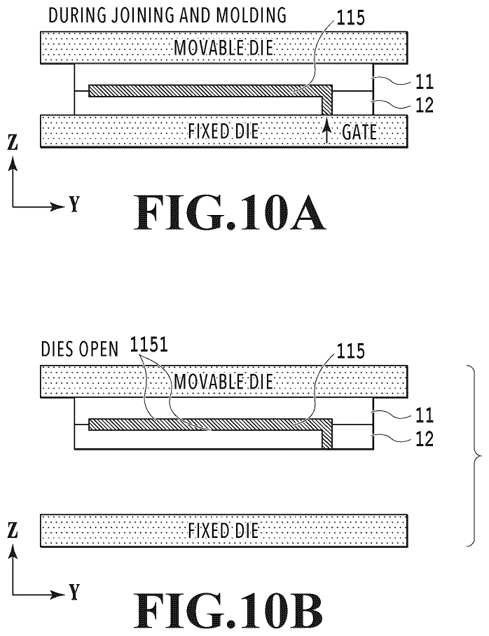

FIGS. 10A and 10B are schematic diagrams showing a prior art molding process, as a comparative example. In such molding, an anchor portion is not formed in either the first molded product 11 or the second molded product 12. Thus, at the time of opening the dies, stress caused by demolding resistance occurring between the fixed die and the second molded product concentrates at joint interfaces 115, leading to defective molding due to interface delamination.

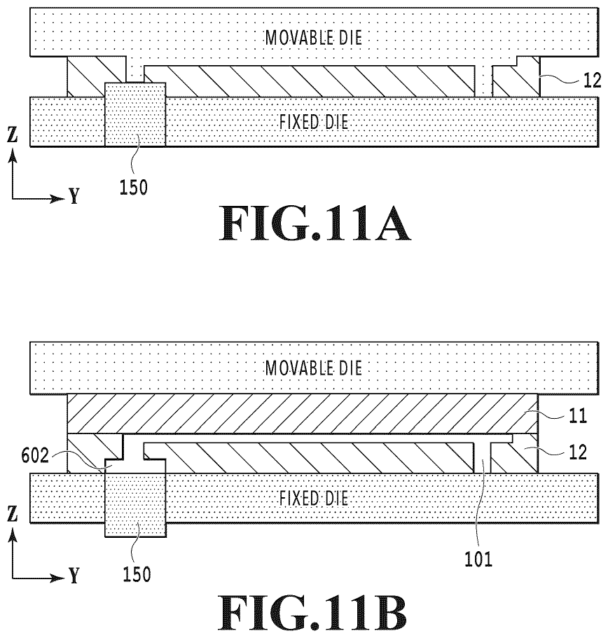

FIGS. 11A and 11B are diagrams showing a method for forming the anchor formation portion 602 at the second molded product 12 in the first molding. As shown in FIG. 11A, an anchor shape forming portion 150 is provided in the fixed die to form the anchor formation portion 602. The anchor shape forming portion 150 can move up and down in the Z-direction. In the first molding, the anchor shape forming portion 150 protrudes more in the +Z-direction than the upper surface of the fixed die.

With the dies opened after the first molding, the second molded product 12 is held on the fixed die, and the first molded product 11 molded at a different location is held on the movable die. After the dies are opened, the anchor shape forming portion 150 is moved down in the −Z-direction to level with the upper surface of the fixed die.

FIG. 11B illustrates a state where the dies are closed after the movable die has been moved in the Y-direction with the dies open to make the first molded product 11 face the second molded product 12. Joining of the first molded product 11 and the second molded product 12 is performed in this state. In the joining step, the anchor shape forming portion 150 of the fixed die moves in the −Z-direction, forming the hollow anchor formation portion 602 at a position where the anchor shape forming portion 150 formerly protruded in the first molding. A joining resin in liquid form is poured through the gate portion 101 into the anchor formation portion 602, forming the anchor portion 603 as shown in FIG. 9B.

The anchor shape forming portion 150 may be moved using air power, to form the anchor formation portion 602.

The following describes a process of molding the flow channel member 110 of the present embodiment described with reference to FIG. 8 using the method described with reference to FIGS. 9A to 9D. In the present embodiment, the first layer 211, the second layer 212, the third layer 213, and the fourth layer 214 are joined together to mold the flow channel member 110.

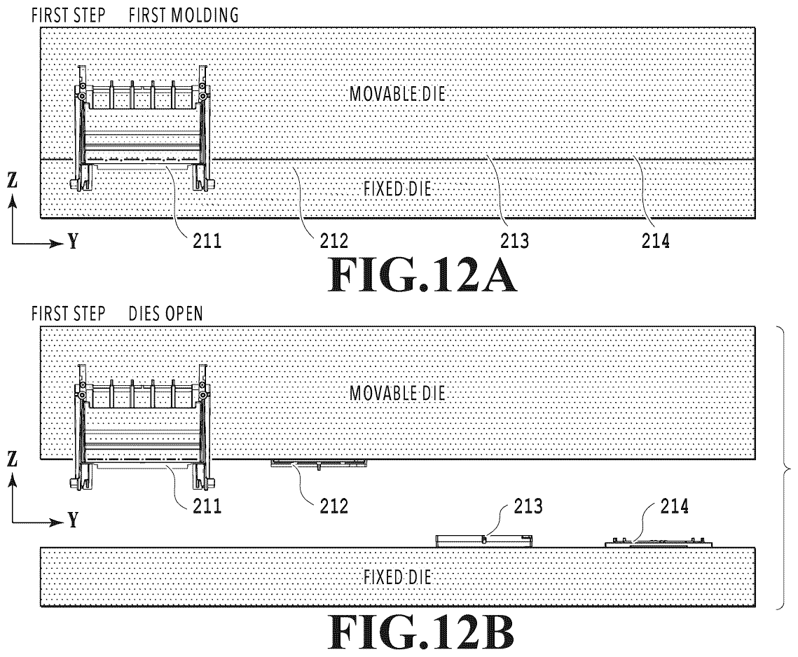

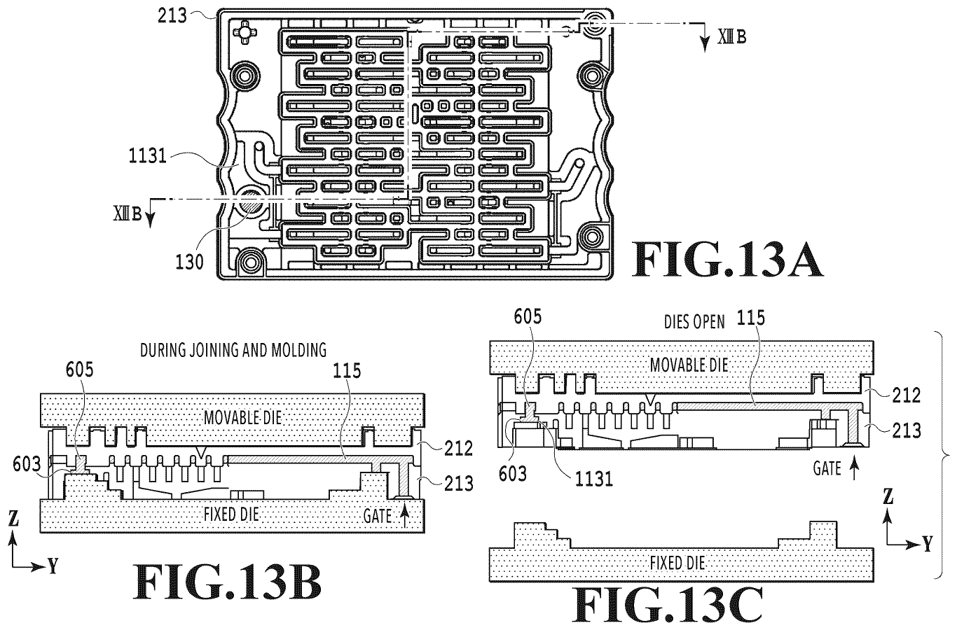

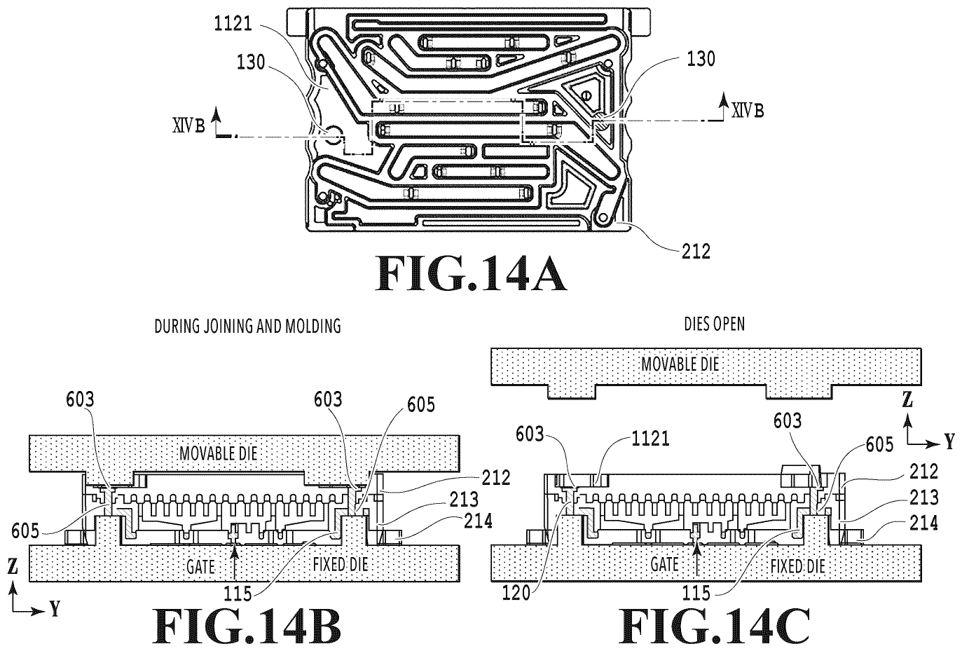

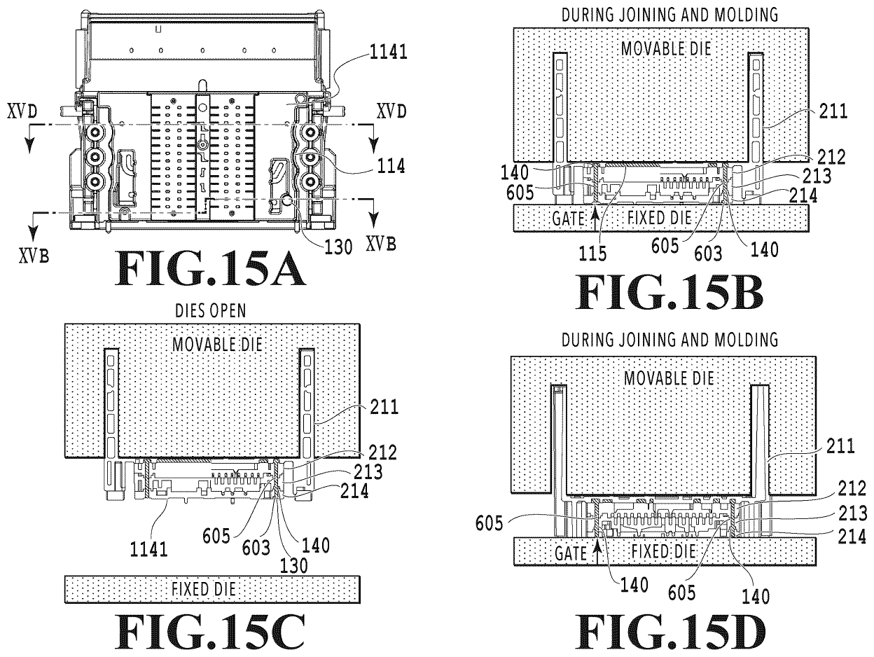

FIGS. 12A and 12B are diagrams showing a first step of the process of molding the flow channel member 110. The Z-direction and the Y-direction are the same as those in FIG. 8. FIG. 13A is a diagram showing the third layer 213, and FIGS. 13B and 13C are diagrams showing a section taken along XIIIb-XIIIb in FIG. 13A to show a second step of the process of molding the flow channel member 110. FIG. 14A is a diagram showing the second layer 212, and FIGS. 14B and 14C are diagrams showing a section taken along XIVb-XIVb in FIG. 14A to show a third step of the process of molding the flow channel member 110. FIG. 15A is a diagram showing the fourth layer 214. FIGS. 15B and 15C are diagrams showing a section taken along XVb-XVb in FIG. 15A to show the third step of the process of molding the flow channel member 110, and FIG. 15D is a diagram showing a section taken along XVd-XVd in FIG. 15A to show a fourth step of the process of molding the flow channel member 110.

The molding process has four steps. In the first step, the components, namely the first layer to the fourth layer (211, 212, 213, 214, respectively), are individually molded at different locations inside dies (see FIG. 12A). After the components are molded, the dies are opened, with the first layer 211 and the second layer 212 being held on the movable die and the third layer 213 and the fourth layer 214 being held on the fixed die (see FIG. 12B). After that, the second to fourth steps of joining and molding are performed while moving the dies.

In the second step, the second layer 212 and the third layer 213 are joined. The movable die is moved in the Y-direction to bring the second layer 212 to a position facing the third layer 213, and the dies are closed to join the second layer 212 and the third layer 213 using the joining resin 115. An opening in the third layer 213 is used as a gate, and the joining resin is injected into the hollow space formed by joint surfaces of the second layer 212 and the third layer 213 (see FIG. 13B). After the injection is completed, the dies are opened, with a joined component formed by the second layer 212 and the third layer 213 being held on the movable die (see FIG. 13C).

From the gate portion in the third layer 213, the joining resin 115 runs between the joint surfaces of the second layer 212 and the third layer 213 extending in the Y-direction and penetrates to a surface 1131 opposite from the surface joined to the second layer 212. This penetrating is by the penetration portion 605, which has the anchor portion 603. Viewed in the lamination direction (the Z-direction), the anchor portion 603 (second region) has a larger cross-sectional area than the remaining area (first region 606, FIG. 9B) of the penetration portion 605. Having such a shape, the anchor portion 603 can function as an anchor, reducing damage on the joint surface which would be caused by the component being stuck in the fixed die as the dies are opened. The anchor portion 603 is provided at one location here.

The third step joins the joined component formed by the second layer 212 and the third layer 213 to the fourth layer 214. With the joined component formed by the second layer 212 and the third layer 213 being held on the movable die, as shown in FIG. 13C, and the fourth layer 214 held on the fixed die, the movable die is moved in the Y-direction to bring the joined component formed by the second layer 212 and the third layer 213 to a position facing the fourth layer 214. The dies are then closed, and the components are joined with the joining resin 115 (see FIG. 14B). Using an opening in the fourth layer 214 as a gate, the joining resin 115 is injected to a hollow space formed by the joint surfaces of the third layer 213 and the fourth layer 214. After the injection is completed, the dies are opened, with a joined component formed by the second layer 212, the third layer 213, and the fourth layer 214 being held on the fixed die (see FIG. 14C).

The joining resin 115 forms the penetration portion 605 penetrating from the fourth layer 214 to a surface 1121 opposite from the joint surface between the second layer 212 and the third layer 213. The penetration portion 605 includes the anchor portion 603. The penetration portion 605 in this step penetrates two layers: the third layer 213 and the second layer 212. Viewed in the lamination direction (the Z-direction), the anchor portion 603 has a larger cross-sectional area than the rest of the penetration portion 605. Having such a shape, the anchor portion 603 functions as an anchor, reducing damage on the joint surface which would be caused by the component being stuck in the fixed die as the dies are opened. In this embodiment, the anchor portion 603 is provided at two locations.

The fourth step joins the joined component formed by the second layer 212, the third layer 213, and the fourth layer 214 to the first layer 211. The joined component formed by the second layer 212, the third layer 213, and the fourth layer 214 is held on the fixed die as shown in FIG. 14C, and the first layer 211 is held on the movable die. In this state, the movable die is moved in the Y-direction to bring the first layer 211 to a position facing the joined component formed by the second layer 212, the third layer 213, and the fourth layer 214. Then, the dies are closed, and the components are joined with the joining resin 115 (see FIG. 15B). Using an opening in the fourth layer 214 as a gate, the joining resin 115 is injected into a hollow space formed by the joint surfaces of the first layer 211 and the second layer 212. After the injection is completed, the dies are opened, with a joined component formed by the first layer 211, the second layer 212, the third layer 213, and the fourth layer 214 being held on the movable die (see FIG. 15C). This joined component is the flow channel member 110 as a finished product of the present embodiment of the molding process.

The joining resin 115 forms the penetration portion 605 extending from the first layer 211 to a surface 1141 of the fourth layer 214 opposite from the surface joined to the third layer 213, and the penetration portion 605 includes the anchor portion 603 with the superficial portion 130. The penetration portion 605 in this step penetrates the second layer 212, the third layer 213, and the fourth layer 214 and reaches the surface 1141 of the fourth layer 214 opposite from the surface joined to the third layer 213. The joining resin 115 includes an enlarged portion 140 forming part of the penetration portion 605, at the interface between the third layer 213 and the fourth layer 214. This enlarged portion 140 too functions as an anchor. The joining resin 115 has another enlarged portion 140 forming part of the penetration portion 605 and functioning as an anchor, at the interface between the first layer 211 and the second layer 212. The anchor portion 603, including the superficial portion 130, is formed with the superficial portion 130 serving as part of the surface 1141.

Viewed in the lamination direction (the Z-direction), the anchor portion 603 and the enlarged portion 140 each have a larger cross-sectional area than the rest of the penetration portion 605, and the anchor portion 603 and the enlarged portion 140 each have an anchoring function.

The enlarged portion 140 and the anchor portion 603 both have an anchoring function, and either the enlarged portion 140 or the anchor portion 603 may be relatively larger or smaller in terms of their cross-sectional areas.

Also, as shown in FIG. 15D, two anchor shapes having the enlarged portion 140 are provided. Then, the anchors are formed at four comers (see FIG. 15A), for improved stability.

Although the superficial portion 130 is circular in the example described above, the present disclosure is not limited to such shape as long as the anchor portion 603 has a larger cross-sectional area than the rest of the penetration portion, viewed in the lamination direction (the Z-direction).

The flow channel member 110 is formed as a result of the above process.

### (Modification)

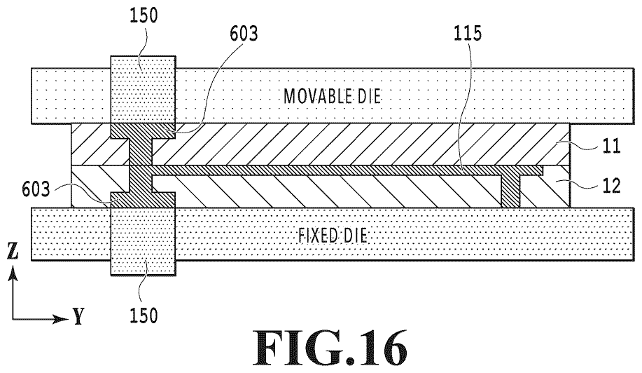

FIG. 16 is a schematic diagram illustrating a modification of the molding process in FIGS. 9A to 11B. In the present modification, the anchor portion 603 is formed in both of the first molded product 11 and the second molded product 12. Because the first molded product 11 and the second molded product 12 both have the anchor portion 603, both of the first molded product 11 and the second molded product 12 provide the anchoring effect. Thus, joining strength is reinforced at both of the joint interface between the first molded product 11 and the joining resin 115 and the joint interface between the second molded product 12 and the joining resin 115, thus reducing damaging on the joint surface. The anchor portion 603 may be formed in at least one of the first molded product 11 and the second molded product 12.

The present embodiment provides the anchor shape forming portion 150 (see FIGS. 11A and 11B) in the movable die. Because the movable die may not have a power source for driving the anchor shape forming portion 150, cost may increase. However, regardless of cost increase, the present embodiment may be employed in a case where to reduce damage at the joint surface at both of the joint interface between the first layer 211 and the joining resin 115 and the joint interface between the second layer 212 and the joining resin 115.

In this way, according to the present embodiment, the joining resin 115 forms the penetration portion 605 in at least one of the first molded product 11 and the second molded product 12, the penetration portion 605 penetrating through the molded product in a lamination direction in which these molded products are laminated. Then, the penetration portion 605 has the anchor portion 603 having a larger cross-sectional area than the rest of the penetration portion 605. A technique for reducing product damage is thus be provided.

### Second Embodiment

A second embodiment of the present disclosure is described below with reference to the drawings. The second embodiment has the same basic configuration as the first embodiment, and the description of common components and methods of the first embodiment is incorporated by reference, for conciseness.

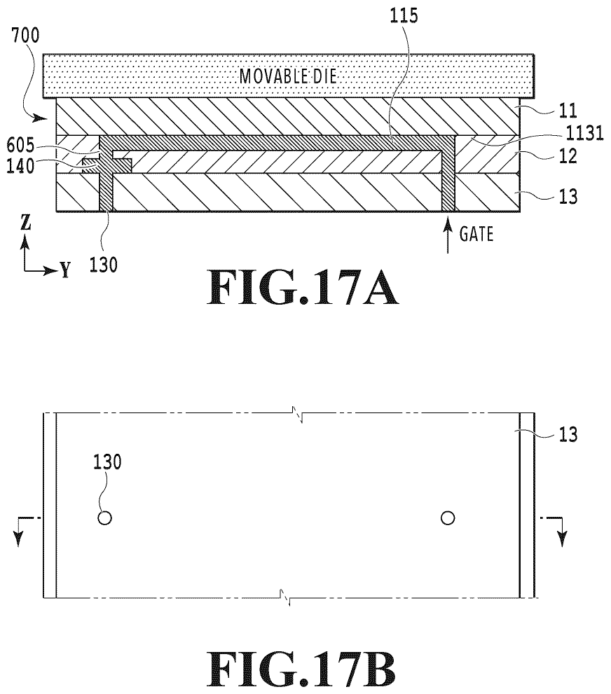

FIGS. 17A and 17B are schematic diagrams of the molding process, showing a joining resin used in molding a joined product 700 of the present embodiment. The present embodiment describes the joined product 700 formed by three members: the first molded product 11, the second molded product 12, and a third molded product 13. In the present embodiment, the joined product 700 is formed by three steps, with FIG. 17A showing a state where the dies are open after the third step.

In the first step, the first molded product 11, the second molded product 12, and the third molded product 13 are individually molded at different locations in the dies. The dies are opened after the molding, with the third molded product 13 being held on the fixed die and the first molded product 11 and the second molded product 12 being held on the movable die.

In the second step, after the movable die is moved in the Y-direction to bring the second molded product 12 to a position facing the third molded product 13, the dies are closed, and the components are joined with the joining resin 115. In this event, using an opening in the third molded product 13 as a gate (a gate portion), the joining resin 115 is injected to a hollow space formed by the joint surfaces of the second molded product 12 and the third molded product 13. After the injection is completed, the dies are opened, with a joined component formed by the second molded product 12 and the third molded product 13 being held on the fixed die.

In the third step, the joined component formed by the second molded product 12 and the third molded product 13 and the first molded product 11 are joined to each other. The movable die is moved in the Y-direction to bring the first molded product 11 to a position facing the joined component formed by the second molded product 12 and the third molded product 13 in the dies, and the components are joined with the joining resin 115. Using an opening in the third molded product 13 as a gate, the joining resin 115 is injected into a penetration space extending from the third molded product 13 to the first molded product 11 and into a hollow space formed by the joint surfaces of the first molded product 11 and the second molded product 12. After the injection is completed, a joined component formed by the first molded product 11, the second molded product 12, and the third molded product 13 is held on the movable die (see FIG. 17A).

The joining resin 115 forms the penetration portion 605 penetrating from the third molded product 13 to the joint surface 1131 between the first molded product 11 and the second molded product 12. The penetration portion 605 has the superficial portion 130 and the enlarged portion 140. The penetration portion 605 formed in the third step penetrates through the second molded product 12 and the third molded product 13 and reaches a joint surface 1131 between the first molded product 11 and the second molded product 12. FIG. 17B provides a view of the superficial portion 130 of the penetration portion 605.

The penetration portion 605 has the enlarged portion 140 between the joint surface 1131 and the superficial portion 130, and the enlarged portion 140 has a larger cross-sectional area than the rest of the penetration portion 605 viewed in the lamination direction (the Z-direction). Meanwhile, the superficial portion 130 has the same cross-sectional area as the penetration portion 605. The anchoring effect achieved by the enlarged portion 140 reduces the likelihood of interface delamination at the joint interface between the joining resin 115 and the second molded product 12. An anchor portion having a larger cross-sectional area than the rest of the penetration portion 605 viewed in the lamination direction (the Z-direction) may be formed at the position of the superficial portion 130.

Providing such an anchor portion requires a mold mechanism and may be difficult to configure. In such a case, the anchoring effect can be achieved by, instead of providing an anchor portion, providing the enlarged portion 140 at a midpoint of the penetration portion 605.

The molding method of the present embodiment can be employed similarly to the first embodiment to mold the flow channel member 110 described with FIG. 8.

### Third Embodiment

A third embodiment of the present disclosure is described below with reference to the drawings. The third embodiment has the same basic configuration as the first embodiment, and the description of common components and methods of the first embodiment is incorporated by reference, for conciseness.

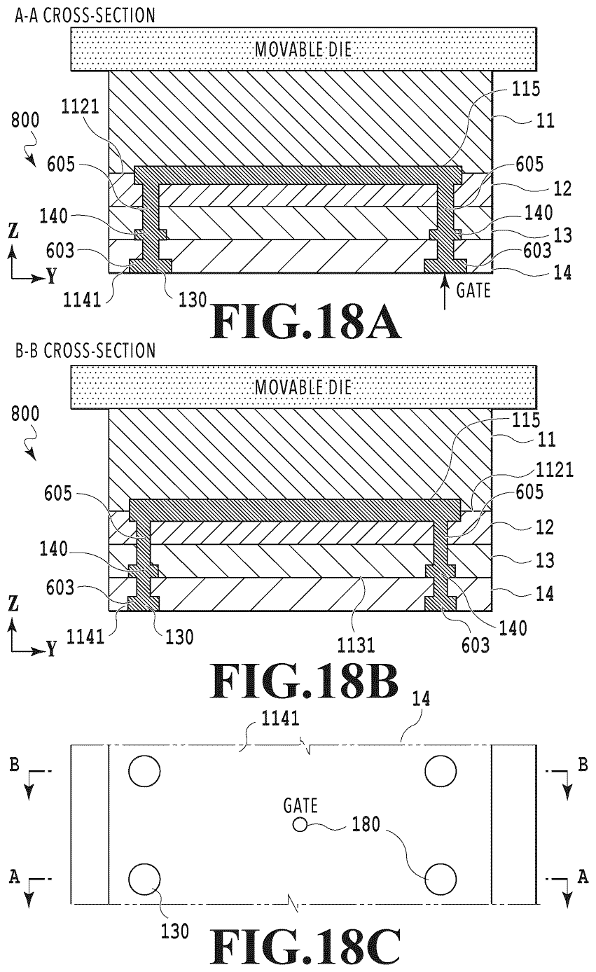

FIGS. 18A to 18C are schematic diagrams of the molding process, showing a joining resin used in molding a joined product 800 of the present embodiment. The present embodiment describes the joined product 800 formed by four members: the first molded product 11, the second molded product 12, the third molded product 13, and a fourth molded product 14. In the present embodiment, the joined product 800 is molded by four steps, with FIG. 18A showing a state where the dies are open after the fourth step.

In the first step, the first molded product 11, the second molded product 12, the third molded product 13, and the fourth molded product 14 are molded individually. The dies are then opened, with the third molded product 13 and the fourth molded product 14 being held on the fixed die, and the first molded product 11 and the second molded product 12 being held on the movable die.

In the second step, after the movable die is moved in the Y-direction to bring the second molded product 12 to a position facing the third molded product 13, the dies are closed, and the components are joined with the joining resin 115. In this event, using an opening in the third molded product 13 as a gate, the joining resin 115 is injected to a hollow space formed by the joint surfaces of the second molded product 12 and the third molded product 13. After the injection is completed, the dies are opened, with a joined component formed by the second molded product 12 and the third molded product 13 being held on the movable die.

In the third step, after the movable die is moved in the Y-direction to bring the joined component formed by the second molded product 12 and the third molded product 13 to a position facing the fourth molded product 14 in the dies, the dies are closed, and the components are joined with the joining resin 115. In this event, using an opening in the fourth molded product 14 as a gate, the joining resin 115 is injected into a hollow space formed by the joint surfaces of the third molded product 13 and the fourth molded product 14. After the injection is completed, the dies are opened, with a joined component formed by the second molded product 12, the third molded product 13, and the fourth molded product 14 being held on the fixed die.

In the fourth step, after the movable die is moved in the Y-direction to bring the first molded product 11 to a position facing, in the dies, the joined component formed by the second molded product 12, the third molded product 13, and the fourth molded product 14, the dies are closed, and the components are joined with the joining resin 115. In this event, using an opening at the surface 1141 of the fourth molded product 14 of the joining resin 115 as a gate 180 (see FIG. 18C), the joining resin 115 is injected to a penetration space extending from the fourth molded product 14 to the first molded product 11 and into a hollow space formed at the joint surface 1121 between the first molded product 11 and the second molded product 12. FIG. 18C provides a view of the gate 180 and the opening at the surface 1141 of the fourth molded product 14.

The joining resin 115 forms the penetration portion 605 extending from the fourth molded product 14 to the joint surface between first molded product 11 and the second molded product 12, and the penetration portion 605 has the anchor portion 603, the superficial portion 130, and the enlarged portion 140. The enlarged portion 140 and the anchor portion 603 are connected in the lamination direction (the Z-direction), and viewed in the lamination direction, the enlarged portion 140 and the anchor portion 603 each have a larger cross-sectional area than the rest of the penetration portion 605. The anchoring effect achieved by the enlarged portion 140 and the anchor portion 603 reduces the likelihood of interface delamination at the joint interface.

The enlarged portion 140 may be provided at the joint portion between the second molded product 12 and the third molded product 13.

The molding method of the present embodiment can be employed similarly to the first embodiment to mold the flow channel member 110 described with FIG. 8.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-191485, filed Oct. 31, 2024, which is hereby incorporated by reference herein in its entirety.

What is claimed is:

1. A flow channel member comprising:
a first molded product;
a second molded product configured to be laminated to the first molded product in a lamination direction;
a resin configured to join the first molded product and the second molded product to each other; and
a penetration portion of the resin, wherein
the penetration portion penetrates at least one of the first molded product and the second molded product in the lamination direction, and
the penetration portion includes a first region and a second region having a larger cross-sectional area than the first region, viewed in the lamination direction.

2. The flow channel member according to claim 1, wherein
the second region of the penetration portion is provided at a superficial portion of the first molded product or the second molded product.

3. The flow channel member according to claim 1, further comprising a third molded product configured to be laminated to the second molded product in the lamination direction.

4. The flow channel member according to claim 3, wherein
the penetration portion includes a third region having a cross-sectional area larger than the first region and different from the second region, viewed in the lamination direction.

5. The flow channel member according to claim 1,
wherein the penetration portion of the joining resin is formed as:
a first penetration portion configured to penetrate the first molded product in the lamination direction, and
a second penetration portion configured to penetrate the second molded product in the lamination direction,
wherein the first penetration portion includes the first region and the second region, provided at a superficial portion of the first molded product,
wherein the second penetration portion includes a third region and a fourth region, provided at a superficial portion of the second molded product, and
wherein the fourth region has a larger cross-sectional area than the third region, viewed in the lamination direction.

6. The flow channel member according to claim 1, wherein
the penetration portion penetrates through a plurality of molded products in the lamination direction.

7. The flow channel member according to claim 6, wherein
the resin has a plurality of the penetration portions.

8. The flow channel member according to claim 1, wherein
the penetration portion penetrates through the first molded product in the lamination direction,
the resin has a gate portion which penetrates through the first molded product in the lamination direction at a location different from a location of the penetration portion, the gate portion being configured to be used to pour the resin in liquid form for joining the first molded product and the second molded product to each other.

9. The flow channel member according to claim 1, wherein
the penetration portion penetrates through the first molded product in the lamination direction, and
the resin has a gate portion which penetrates through the second molded product in the lamination direction, the gate portion being configured to be used to pour the resin in liquid form for joining the first molded product and the second molded product to each other.

10. A liquid ejection head comprising:
the flow channel member according to claim 1 and
a liquid ejection unit configured to eject liquid supplied from the flow channel member.

11. The flow channel member according to claim 8, further comprising:
an internal channel configured for the liquid resin to flow within.

12. The flow channel member according to claim 9, further comprising:
an internal channel configured for the liquid resin to flow within.

13. A method for molding a flow channel member, the method comprising:
a first molding step of molding a first molded product; and
a second molding step,
wherein a second molded product is formed in a plurality of dies,
wherein, in the second molding step:
the plurality of dies are opened after the molding of the first molded product,
at least one die of the plurality of dies is moved to a position in which the first molded product and the second molded product face each other in a lamination direction,
the dies are closed, and
a resin is poured into a space formed at a location where the first molded product and the second molded product abut against each other to join the first molded product and the second molded product to each other,
wherein the space includes a penetration space penetrating through at least one of the first molded product and the second molded product in the lamination direction,
wherein the penetration space includes a first region and a second region, and
wherein the second region has a cross-sectional area larger than a cross-sectional area of the first region, viewed in the lamination direction.
